(19) United States
(12) Patent Application Publication
(10) Pub. No.: US 2017/0220240 A1
(43) Pub. Date: Aug. 3, 2017

(54) IN-APPLICATION INTERACTIVE NOTIFICATION

(71) Applicant: Uber Technologies, Inc., San Francisco, CA (US)

(72) Inventors: Shruti Kataria, San Francisco, CA (US); Peter Ng, San Francisco, CA (US)

(21) Appl. No.: 15/371,597

(22) Filed: Dec. 7, 2016

Related U.S. Application Data
(60) Provisional application No. 62/288,344, filed on Jan. 28, 2016.

(51) Int. Cl. G06F 3/0488; G06F 3/0484; G06F 3/0482; G06F 3/0481

(52) U.S. Cl. CPC G06F 3/04883; G06F 3/0481; G06F 3/04847; G06F 3/0482; H04L 67/16

(57) ABSTRACT

A system and method of providing information on a computing device is described. A client application can present a user interface on a display of the computing device. An in-application notification can be presented on the display as part of the user interface. The in-application notification can include graphic content and an interactive sliding feature that is responsive to user input. A user input is received corresponding to a gesture in which the interactive sliding feature is moved from a first position to a second position. As the interactive sliding feature moves, the graphic content of the in-application notification can be dynamically adjusted.

### RELATED APPLICATIONS

This application claims benefit of Provisional U.S. Patent Application No. 62/288,344, filed on Jan. 28, 2016; the aforementioned priority application being hereby incorporated by reference in its entirety.

### BACKGROUND

A user of an application can view information associated with a network service by interacting with the application on the user's computing device. In some instances, the network service can transmit data to the computing device to cause the application to display certain content to the user.

### BRIEF DESCRIPTION OF THE DRAWINGS

FIG. 1 illustrates an example system to provide information on a computing device.

FIG. 2 illustrates an example method for providing information on a computing device.

FIG. 3 illustrates an example user interface of an application running on a computing device.

FIG. 4 illustrates another example user interface of an application running on a computing device.

FIGS. 5A through 5F illustrate example user interfaces to depict an operation of an in-application notification.

FIG. 6 is a block diagram that illustrates a computing device upon which embodiments described herein may be implemented.

### DETAILED DESCRIPTION

Examples described herein provide a system that generates and presents an interactive in-application notification or message as part of a user interface of an application. As compared to a standard notification that may be presented in an application, the interactive in-application notification described herein includes an interactive feature that can be manipulated by a user via user input, such as a gesture input. As referred to herein, a gesture input can correspond to a user contact and movement on a touch-sensitive display using a finger or pointing device (e.g., a tap and drag movement). When the user interacts with the interactive feature, the interactive in-application notification can dynamically change its content. For example, the interactive in-application notification can dynamically change its content to better educate the user about the application or associated network service (e.g., inform the user about a particular feature, about a new offer, about how something works, etc.). In this manner, the user can view the information in greater detail (and thus, understand what the notification is informing the user of) as he or she interacts with the interactive feature, as opposed to the user simply ignoring and dismissing the notification from the application.

According to some examples, the system can be implemented on a mobile computing device through use of at least an application that can communicate with a remote system over one or more networks. In other examples, such a remote system can correspond to a service arrangement system that communicates with a service application running on a user's computing device. As referred to herein, a service arrangement system can provide a network service in which requesters can make requests for services and services providers can be selected or assigned to provide those services. The service application can receive data in connection with a location-based service from the service arrangement system. Additionally, the service arrangement system can display information about the service on the service application. In some examples, the service application can receive data and/or be triggered to display an interactive in-application notification as part of the user interface of the service application.

In some examples, the service application can run on a computing device of a user and present, on a touch-sensitive display of the computing device, a user interface (UI). The UI can present information associated with the service arrangement system. According to variations, the UI can include a set of selectable features that each corresponds to a service option or type that can be requested by the user and/or other content associated with the service arrangement system. The service application can be triggered to present an in-application notification as part of the UI. Additionally the in-application notification can include graphic content and/or textual content. Furthermore the in-application notification can include an interactive sliding feature that is responsive to user input. The service application can receive, via the touch-sensitive display, a user input corresponding to a gesture in which the interactive sliding feature of the in-application notification is moved from a first position to a second position. As the interactive sliding feature moves, the graphic content of the in-application notification can be dynamically adjusted accordingly.

Depending on implementation, the system can display different in-application notifications based on prior historical data. The service application can store information locally about prior historical data or can receive data from the remote system that causes the in-application notification to be displayed based on prior historical data. According to some examples, prior historical data can indicate whether the user has interacted with a previous in-application notification, what the in-application notification was pertaining to (e.g., what was the content or subject matter of the in-application notification), and/or whether the user has provided input to request a service relating to the in-application notification or to specify a parameter for the service, etc. In other examples, when the system determines that an in-application notification (corresponding to a particular content) is to be displayed, the system can determine whether the user has previously interacted with the in-application notification. If the user has previously viewed and/or interacted with the in-application notification, the system can cause a different notification, as opposed to the in-application notification, to be displayed. On the other hand, if the user has not previously viewed and/or interacted with the in-application notification, the system can cause the in-application notification to be displayed.

Still further, the in-application notification can pertain to or be associated with a service or a feature, or a promotion or update to a service or a feature, that is provided by the service arrangement system. Based on the subject matter of the in-application notification, the content (e.g., graphical and/or textual content) of the in-application notification can be dynamically adjusted so as to provide informative context for the user as the user interacts with the interactive sliding feature.

In some examples, the interactive sliding feature can be provided on a track and move along the track between a first position and a second position (e.g., start point and end point). In other examples, the interactive sliding feature can correspond to a feature that is a part of the graphical content that can move along a graphic path between a first position and a second position.

Among other benefits and technical effect, examples described herein improve mobile messaging or in-application notification technology. The examples contemplate that many users of client applications ignore or do not give full attention to messages or notifications that are sent to their devices. Typically, a user can quickly dismiss a notification by providing input on a selectable button (e.g., selecting “Close” or “X”) or by providing input on a portion of the screen away from the notification. Additionally, because the amount of real estate of a display screen of a device is limited in size, typical notifications can contain only a very limited amount of content. The content may not necessarily be helpful or effective in informing a user of the information the notification is meant to portray. As compared to a typical notification, the in-application notification as described herein can educate the user more efficiently by dynamically changing the content in an informative way so that a user can understand the operation of a service or what the notification is about as the user interacts with an interactive feature of the notification. Furthermore, the user's interaction with the interactive feature can dismiss the notification, thereby requiring the user to have to interact with the notification to dismiss the notification.

As used herein, a client device, a computing device, and/or a mobile computing device refer to devices corresponding to desktop computers, cellular devices or smartphones, personal digital assistants (PDAs), laptop computers, tablet devices, etc., that can provide network connectivity and processing resources for communicating with the service arrangement system over one or more networks. In another example, a computing device can correspond to an in-vehicle computing device, such as an on-board computer. Also, as described herein, a user, can correspond to a requester of a network service or a service provider (e.g., a driver of a vehicle) that provides location-based services for requesters.

Still further, examples described herein relate to a variety of location-based (and/or on-demand) services, such as a transport service, a food truck service, a delivery service, an entertainment service, etc., to be arranged between requesters and service providers. In other examples, the system can be implemented by any entity that provides goods or services for purchase through the use of computing devices and network(s). For purpose of simplicity, in examples described herein, the service arrangement system can correspond to a transport arrangement system that arranges transport and/or delivery services to be provided for requesters by drivers of vehicles who operate service applications on respective computing devices.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For instance, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

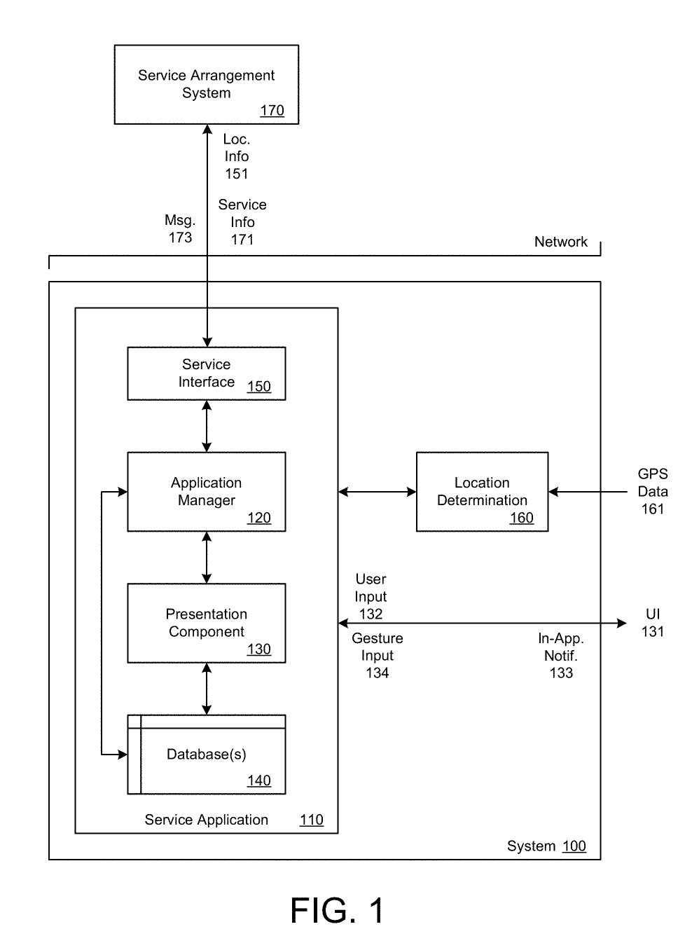

FIG. 1 illustrates an example system 100 to provide information on a computing device. According to an example of FIG. 1, the system 100 can be implemented by and operated on a computing device, such as a mobile computing device (e.g., a smartphone), through execution of instructions stored in one or more memory resources of the computing device. The system 100 can include a service application 110, such as a designated client application that can communicate with a remote service arrangement system 170, a location determination component 160, and/or other components, which not illustrated for purpose of simplicity. Additionally, the system 100 can include a plurality of databases, other applications, other components for controlling and running the computing system, and a plurality of device interfaces to enable the system 100 to communicate with the hardware resources of the computing device. The components of the system 100 can combine to communicate with the service arrangement system 170 and present an in-application notification as part of a UI. Logic can be implemented with various applications (e.g., software) and/or with hardware of the computing device that implements the system 100.

As referred to herein, the service application 110 can correspond to a program (e.g., a set of instructions or code) that is downloaded and stored on the computing device. When running on the computing device, the service application 110 can communicate with the service arrangement system 170 over one or more networks (e.g., cellular network, wireless local area network), and/or other network services. The service arrangement system 170 can be implemented on network side resources, such as on one or more computing systems, servers, or data centers, and/or implemented through other computer systems in alternative architectures (e.g., peer-to-peer networks, etc.). In some examples, the service application 110 can correspond to a requester client application to enable a requester user to view information about a network service and to make a request for a location-based service, or can correspond to a provider client application to enable a service provider to receive invitations for providing services from the service arrangement system. For illustrative purposes, the service application 110 is described in FIG. 1 as a requester client application.

In some examples, the service application 110 can include an application manager 120, a presentation component 130, a set of databases 140, and a service interface 150. The service application 110 can also include other data, such as content to be displayed as UI features for the service application 110, and other dynamic or static data associated with the user or the service application 110. For purpose of simplicity, other information and components of the service application 110 are not illustrated in FIG. 1. In other examples, the application manager 120 can control the operation of the service application 110, including how to process information from the service arrangement system 170. The application manager 120 can also control the presentation component 130 to generate and display UIs for the service application 110. The service interface 150 enables the service application 110 to exchange data between the service application 110 and the service arrangement system 170. For example, the service interface 150 can use one or more network resources of the computing device to exchange communications over one or more wireless networks (e.g., a cellular transceiver, a WLAN transceiver, etc.). The service interface 150 can include or use an application programming interface (API), such as an externally facing API, to communicate data with the service arrangement system 170. The externally facing API can provide access to the service arrangement system 170 via secure access channels over the network through any number of methods, such as web-based forms, programmatic access via RESTful APIs, Simple Object Access Protocol (SOAP), remote procedure call (RPC), scripting access, etc.

A user of the system 100 can launch and operate the service application 110 to view information about one or more service options available to the user. According to some examples, the service application 110 can provide user information (e.g., a user identifier and/or state information) and/or user credentials to the service arrangement system 170 when the service application 110 is launched. The application manager 120 can also communicate with the location determination component 160, which can communicate with a Global Positioning System (GPS) receiver or component of the computing device or other wireless communication sub-systems, to receive or retrieve the location or GPS data 161 (a location data point, such as a latitude and longitude coordinate) corresponding to the current location of the computing device. The service application 110 can provide the current location information 151 of the user/computing device (e.g., the GPS data 161 or based on the GPS data 161) to the service arrangement system 170, e.g., periodically and/or in response to certain user input on the service application 110.

Based on the location information 151, the service arrangement system 170 can provide a set of service information 171 to the service application 110. Depending on implementation, a variety of service options or types may be available to a user depending on where the user is. For example, in San Francisco, Calif., five service options or vehicle types may be available for requesting by a user, whereas in Austin, Tex., three service options or five different service options, as compared to service options in San Francisco, may be available for requesting by the user. The application manager 120 can cause the presentation component 130 to display information about the service options for the user at the user's location, including graphics showing locations of service options (e.g., vehicle images) on map tiles, using the set of service information 171. In some examples, the application manager 120 can also cause the presentation component 130 to display a selection feature UI in which the user can select from the different service options to view information about the selected service option (e.g., estimated time of arrival to the user's current location or specified pickup location, pricing information for the selected service option, size of the vehicle of the service option, etc.).

In some instances, the service arrangement system 170 can transmit a message 173 to the service application 110 to cause the service application 110 to display a notification for the user. For example, an entity that operates or controls the service arrangement system 170 may offer new features or services that were previously unavailable at a geographic region or may offer new promotions, deals, advertisements, etc., or updates/changes to current services or features of services. According to some examples, the service arrangement system 170 can transmit a message 173, which can trigger the service application 110 to display an in-application notification to educate or provide information about a service, feature, changes, etc., to the user. Depending on implementation, the service arrangement system 170 can transmit the message 173 based on one or more factors. Example factors can include: (i) the user identifier, (ii) the location information 151, (iii) the services available for the user at the location information 151, (iv) information about new notifications that are generated at the service arrangement system 170, (v) prior historical data associated with the service application 110 and/or the user, and/or (vi) specified user input received via the service application 110.

In some examples, the application manager 120 can receive the message 173 and cause the presentation component 130 to present an in-application notification 133, as part of the user interface 131 (U1 131) of the service application 110, on a display of the device. Depending on the implementation, in some examples, the message 173 can include data about the in-application notification 133, such as the type of notification, the graphic details of the notification (e.g., pixel dimensions, color scheme), graphic content and/or textual content, and/or selectable features of the notification. Furthermore, the presentation component 130 can use the data from the message 173 to generate and present the in-application notification 133. In other examples, the application manager 120 and/or the presentation component 130 can use the data in the message 173 to select the appropriate notification type and/or template from a notifications database of the set of databases 140. The presentation component 130 can use the data in the message 173 and other stored information about the notification to generate and present the in-application notification 133. In some examples, depending on the data of the message 173 (e.g., depending on what the notification is for or associated with, or depending on the type of notification) and/or depending on stored user data (e.g., prior historical data associated with the user), the presentation component 130 can present an interactive in-application notification 133 or a static, non-interactive in-application notification 133.

In a use case example, a user can select or specify a particular service option (e.g., a vehicle type) on the UI 131 of the service application 110 via a user input 132. The service application 110 can be instructed to display an in-application notification 133 regarding the selected service option. In some examples, the service application 110 can receive a message 173 to display a notification when the set of service information 171 is received, and in response to the user input 132, can present the in-application notification 133. In other examples, the service application 110 can provide data about the user input 132 to the service arrangement system 170, which can then transmit the message 173 to the service application 110. Still further, in other examples, the user can provide input 132 to specify a parameter for a pickup location (and/or a parameter for a destination location) for the service option by selecting a “set pickup location” feature or “make a request” feature on the UI of the service application 110. This can trigger the service application 110 to present the in-application notification 133 associated with the service option.

If the service application 110 displays an interactive in-application notification 133, as part of the UI 131, the in-application notification 133 can include graphic content (and/or textual content) and an interactive sliding feature that is responsive to user input. The graphic content and/or textual content can correspond to the subject of the notification 133, such as to inform the user about a promotion or price deal, a new feature or change to a service option, or a new service option, etc. The interactive sliding feature can be positioned, in the in-application notification 133, at a first position on a track or path (e.g., at default when the in-application notification 133 is displayed), and can be moved along the track or path from the first position to a second or end position.

The user can interact with the interactive slide feature, and as a result of the interaction, the presentation component 130 can dynamically adjust the graphic content within the in-application notification 133. For example, in some examples a user provides gesture input 134 on the display screen to select and move the interactive sliding feature from the first position to the second position. The change in positioning of the interactive sliding feature can cause the presentation component 130 to dynamically adjust the graphic content within the in-application notification 133. By dynamically adjusting the graphic content within the in-application notification 133, the user can visually and efficiently learn about the subject of the notification through illustrations or movement of the graphic content. The dynamic adjustment can further be based on the rate or speed at which the user controls or moves the interactive sliding feature. In other examples, the graphic content can be dynamically adjusted in reverse if the user provides gesture input 134 on the display screen to select and move the interactive sliding feature from the second position, back towards the first position.

In some examples, moving the interactive sliding feature to the second position (e.g., and stops the gesture input 134) can cause the presentation component 130 to further modify the in-application notification 133. For example, the presentation component 130 can further modify the in-application notification 133 by: (i) removing the interactive sliding feature from the in-application notification 133, (ii) changing a size and/or color schemes of the in-application notification 133, (iii) adding, removing, and/or changing the graphic and/or textual content of the in-application notification 133, (iv) providing a selectable feature to dismiss the in-application notification 133, and/or (v) changing the in-application notification 133 from an interactive notification to a static notification. In other examples, when the user moves the interactive sliding feature to the second position, the presentation component 130 can dismiss or remove the in-application notification 133 or dismiss the in-application notification 133 after a specified duration of time (e.g., five seconds). In some examples, the in-application notification 133 can be prevented from being dismissed from the UI 131 of the service application 110 unless the interactive sliding feature is moved from the first position to the second position.

Although the example of FIG. 1 is described with respect to the system 100 being implemented on a user's computing device. In other examples, one or more of the components of the system 100 can be implemented by the service arrangement system 170. In some examples, in-application notification 133 does not need to be associated with a particular feature or a particular service option available to the user, but instead, can be a notification about the user's account, a time-limited and/or geographic-limited promotion, pricing updates, news information, etc. The in-application notification can be presented in a client application when a user launches the client application, when a user selects an out-of-application notification and the client application is subsequently opened, in response to user input, and/or in response to receiving a notification message from a remote system (e.g., push or pull messages).

Methodology

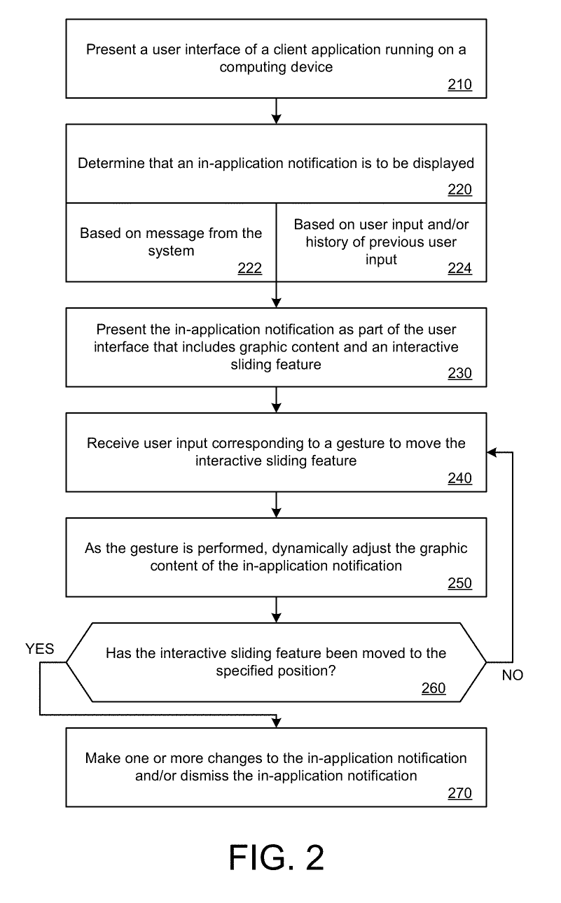

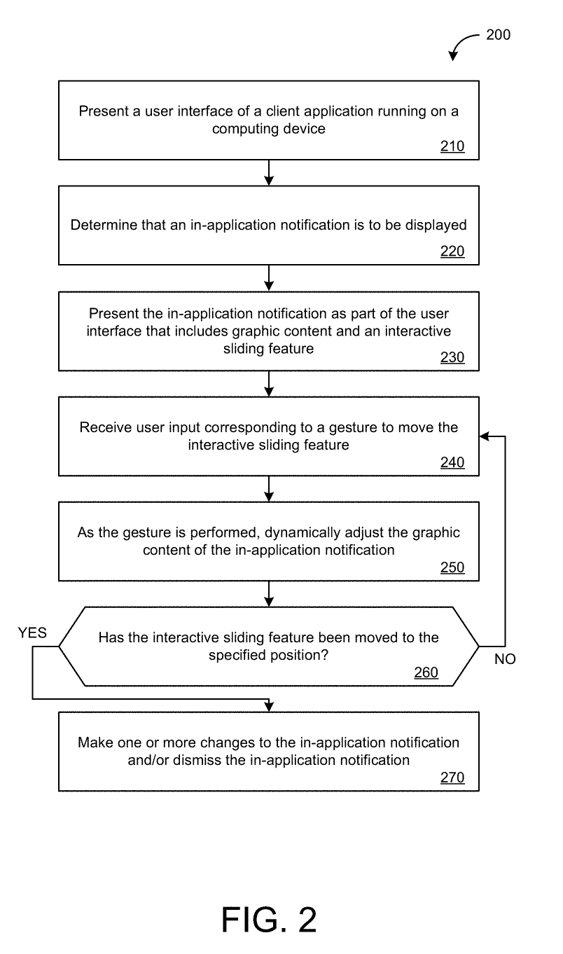

FIG. 2 illustrates an example method 200 for providing information on a computing device. The method such as described by an example of FIG. 2 can be implemented using, for example, components described with the example of FIG. 1. Accordingly, references made to elements of FIG. 1 are for purposes of illustrating a suitable element or component for performing a step or sub-step being described. For illustrative purposes, FIG. 2 is described as being performed by a system or client application of a mobile computing device. However, in other examples, one or more steps of FIG. 2 can be performed by a service arrangement system.

Method 200, begins at step 210, with a client or service application presenting a UI of a client application on a computing device. For example, as illustrated in FIG. 1, a services application 110 controls the presentation component 130 to generate, display and present UIs for the service application 110 on a computing device.

Furthermore, the computing device can be operated by a requester user of a network service or a service provider of the network service. The UI can include information associated with the network service that is available to a user, such as based on the user's current location or other user parameter or characteristic. In some examples, in connection with a delivery or transport service, the UI can include one or more selectable features each corresponding to a service option available for the user, a map of a geographic region of the current location of the computing device, selectable features for specifying one or more user-specified parameters, and/or graphic icons representing locations of service providers of a specified service option on the map.

At step 220, the client application can determine that an in-application notification is to be displayed. In some examples, depending on implementation, the client application can be instructed to present an in-application notification by instructions from a remote system. For example, as illustrated in FIG. 1, a services application 110 can be instructed to present an in-application notification on a computing device based on preprogrammed instructions (e.g., from an initial installing of the client application or from a software update) and/or by instructions or a notification message received from a the service arrangement system.

In other examples, the client application can determine that an in-application notification is to be presented based on user input. For example, as illustrated in FIG. 1, a service application 110 can be instructed to present an in-application notification on a computing device based on user input 132 received from UI 131. User input 132 can be based on a user's selection of a feature on UI 131.

In some examples, the client application can determine an in application notification is to be presented based on user input and/or the historical data associated with the user or just based on the user's historical data. Historical data can include data related to whether the particular in-application notification has been presented before for the user, whether the user has provided previous user input in connection with the in-application notification, or whether the user has provided previous user input on the UI to specify a parameter of a service option associated with the in-application notification or made a request for the service option. Furthermore, as illustrated in FIG. 1, database(s) 140 can include data associated with the user or historical data.

In some examples, the client application can be instructed to display an interactive in-application notification or display a static in-application notification. For instance, the client application can determine which type of in-application notification to present based on the data from the notification message and/or historical data associated with the user. In some examples, as illustrated in FIG. 1, the service application 110 can be instructed to display an in-application notification about a first service option. The service application 110 can determine whether the user has already viewed or interacted with the in-application notification or whether the user has requested the first service option before (i.e., historical data associated with the user). If the service application 110 determines the user has already viewed or interacted with the in-application notification, or the user has requested the first service option before, the client application can present a static in-application notification about the first service option. In some examples, the service application 110 does not display any notification about the first service option. On the other hand, if the service application 110 determines the user has not viewed or interacted with the in-application notification, or the user has never requested the first service option before, the service application 110 can present an interactive in-application notification.

In other examples a remote system instructs client application to present an interactive in-application notification or a static in-application notification. For example, as illustrated in FIG. 1, service arrangement system 170 instructs service application 110 to display an in-application notification based on the historical data associated with a user. For instance, it is the service arrangement system 170, instead of the service application 110, that determines whether the user has already viewed or interacted with the in-application notification, or previously requested the first service option.

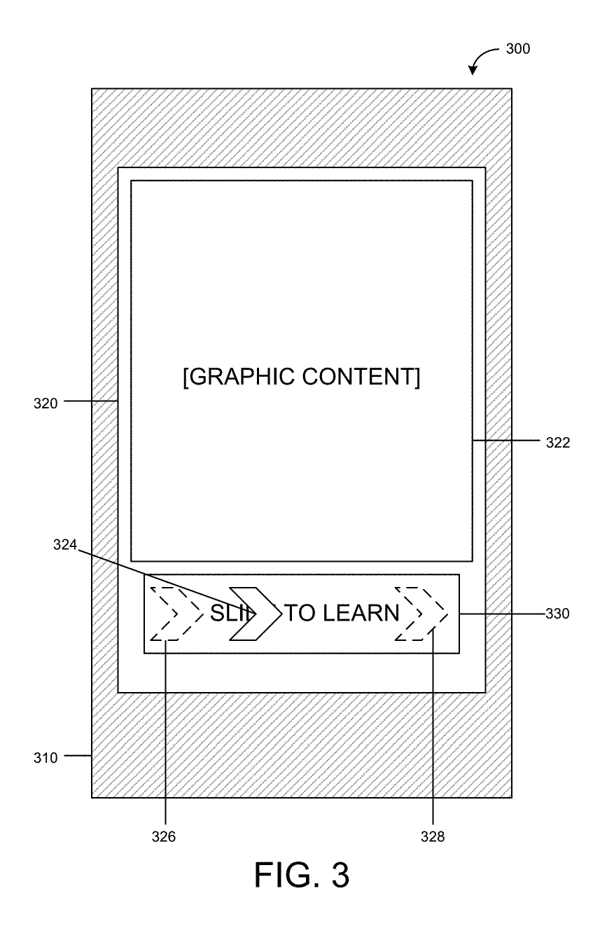

In step 230, the client application can present the interactive in-application notification, as part of the UI, that includes graphic content (and/or textual content) and an interactive sliding feature. For example, as illustrated in FIG. 1, upon determining that an in-application notification is to be displayed, service application 110 can present in-application notification 133 on UI 131. An example in-application notification is illustrated in FIG. 3. FIG. 3, illustrates an example UI 300 of an application running on a computing device. As illustrated in FIG. 3, example UI 300 includes content 310 that was previously presented on the computing device before the in-application notification 320 is presented. The in-application notification 320 can be presented as a representation of a panel that overlays the content 310 of the UI. In one example, the visual characteristics or appearance of the content 310 can be adjusted when the in-application notification 320 is displayed (e.g., distort the content 310, shade the content 310, etc.) so as to provide focus for the user on the in-application notification 320. The in-application notification 320 can include graphic content 322 (e.g., dynamic graphic content that can be adjusted based on the user's gesture input) and/or textual content, and an interactive sliding feature 324. According to the example of FIG. 3, the interactive sliding feature 324 is provided on a track 330 defined by a pair of lateral edges and having a first position 326 and a second position 328. The interactive sliding feature 324 can be positioned at the first position by default when the in-application notification 320 is displayed.

Referring back to method 200, at step 240, the client application (e.g., service application 110) can receive user input corresponding to a gesture (e.g., gesture input 134) to move the interactive sliding feature on a UI (e.g., UI 131). For example, as illustrated in FIG. 3, the user can tap and hold (e.g., on a touch-sensitive display of the computing device) the interactive sliding feature 324 and drag, via the gesture input, the interactive sliding feature 324 from the first position 326 to the second position 328. As the gesture is being performed, the client application can dynamically adjust the graphic content 322 of the in-application notification 320 (250). The client application can dynamically adjust the graphic content 322 (and/or textual content) in a way that visually informs or educates the user about a new feature or service option, a new promotion, an event, etc. Furthermore, in some examples, the in-application notification can be configured to only enable the user to move the interactive sliding feature at a certain speed or rate so that the graphic content 322 is adjusted accordingly at a certain speed or rate.

In step 260, the client application can determine whether the interactive sliding feature has been moved to a specified position, such as the second position. According to examples, if the user has not moved the interactive sliding feature to the specified position, the client application can continue to dynamically adjust the graphic content of the in-application notification. For instance, as illustrated in FIG. 3, if the user begins to move the interactive sliding feature 324 from a first position 326 but does not move the interactive sliding feature 324 to a second position 328, the service application 110 can continue to dynamically adjust graphic content 322 of the in-application notification.

In step 270, if the user has moved the interactive sliding feature to the specified position, in response, the client application can make one or more changes to the in-application notification and/or dismiss the in-application notification. In some examples, depending on implementation, the client application (e.g., the service application 110) can change the visual characteristics of the in-application notification by (i) removing the interactive sliding feature (and/or the track), (ii) changing textual and/or graphic content and/or providing new textual and/or graphic content, (iii) providing one or more selectable features that were previously not in the in-application notification (e.g., such as a feature to enable the user to dismiss or remove the in-application notification from the UI), (iv) changing the size of the in-application notification, and/or (iv) removing the in-application notification from the UI.

Use Case Examples

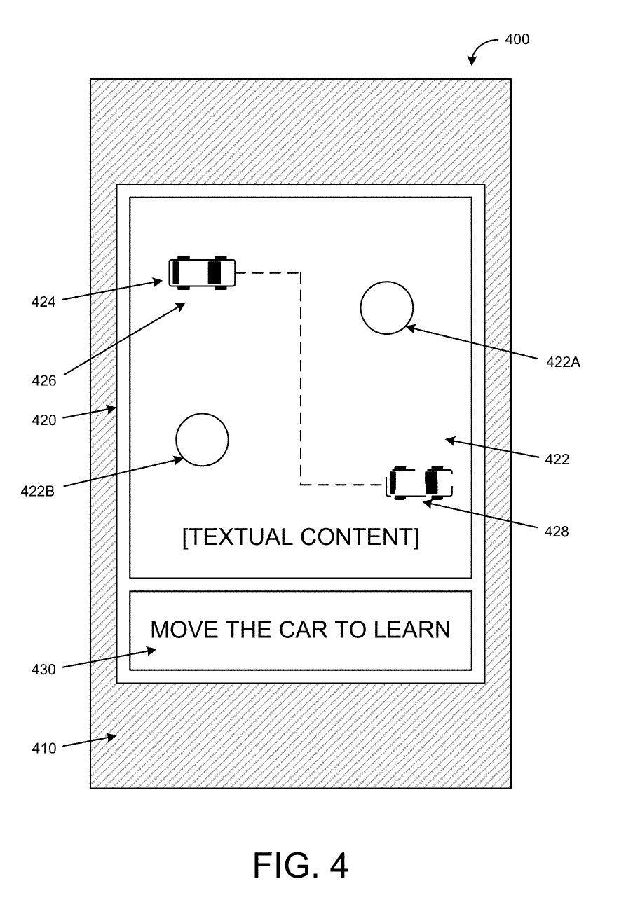

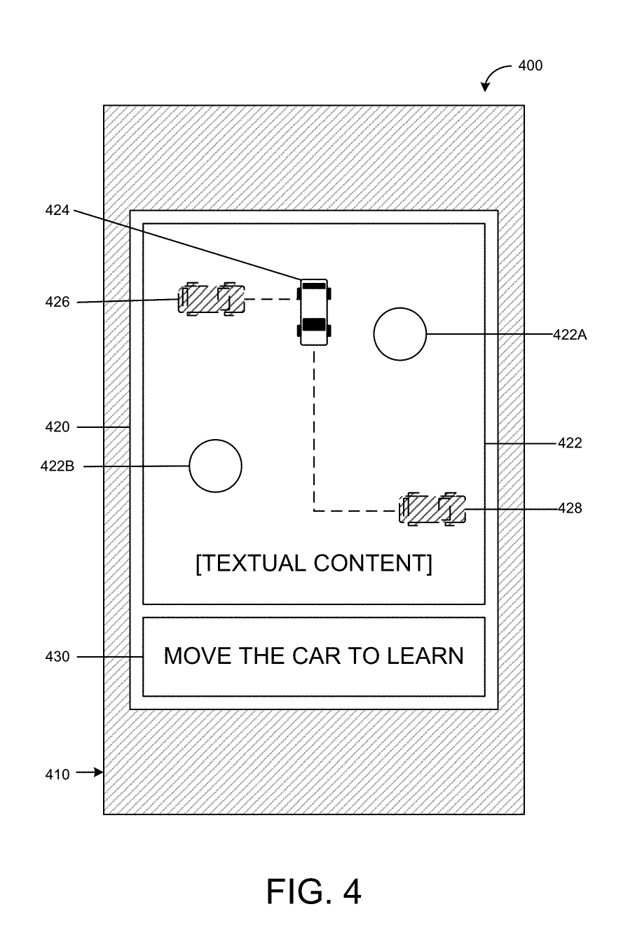

FIG. 4 illustrates another example UI of an application running on a computing device and displaying an in-application notification. The UI 400 can include an interactive in-application notification 420 that overlays content 410 of the UI 400. However, as compared to the example of FIG. 3, the in-application notification 420 can include an interactive sliding feature 424 that is a part of the graphic content 422. The interactive sliding feature 424 can be positioned at a first position 426 along a path (e.g., shown by a dotted line) and can be moved via user input to the second position 428 (e.g., indicated by a graphic icon). The graphic content 422 can include one or more graphic elements or items 422A, 422B that can dynamically change or move as the interactive sliding feature 424 is moved by the user via gesture input. The in-application notification 420 can also include textual content, including instructions 430 to inform the user what to do in order to interact with the in-application notification 420.

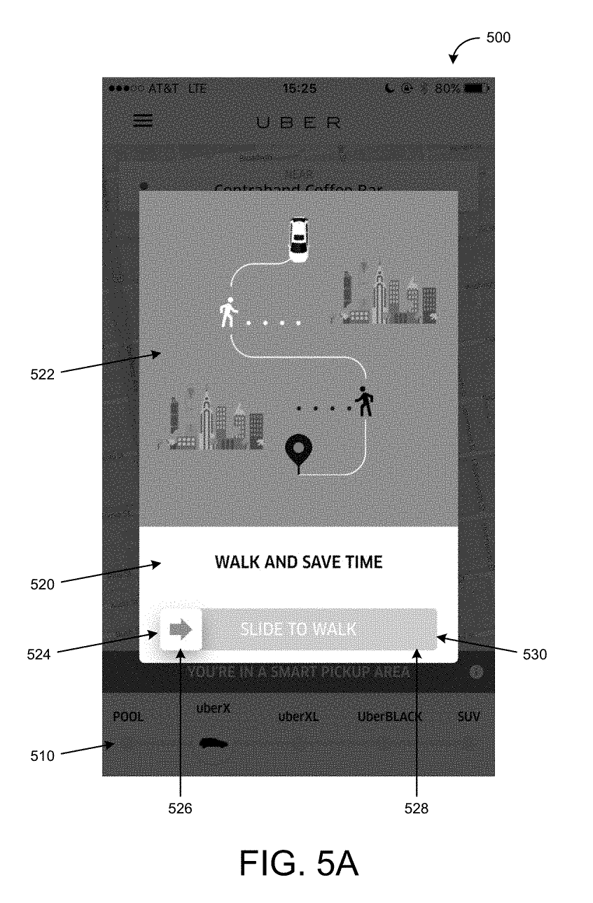

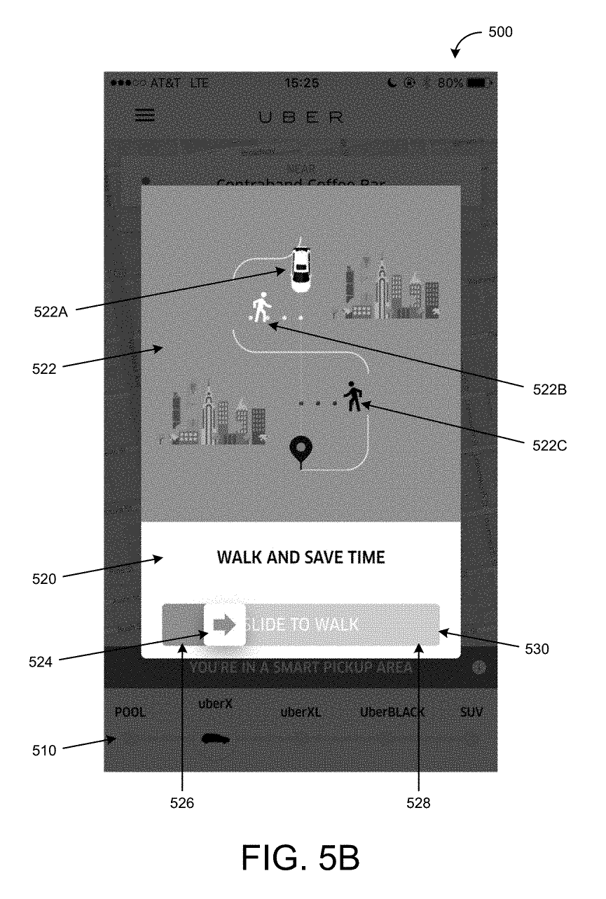

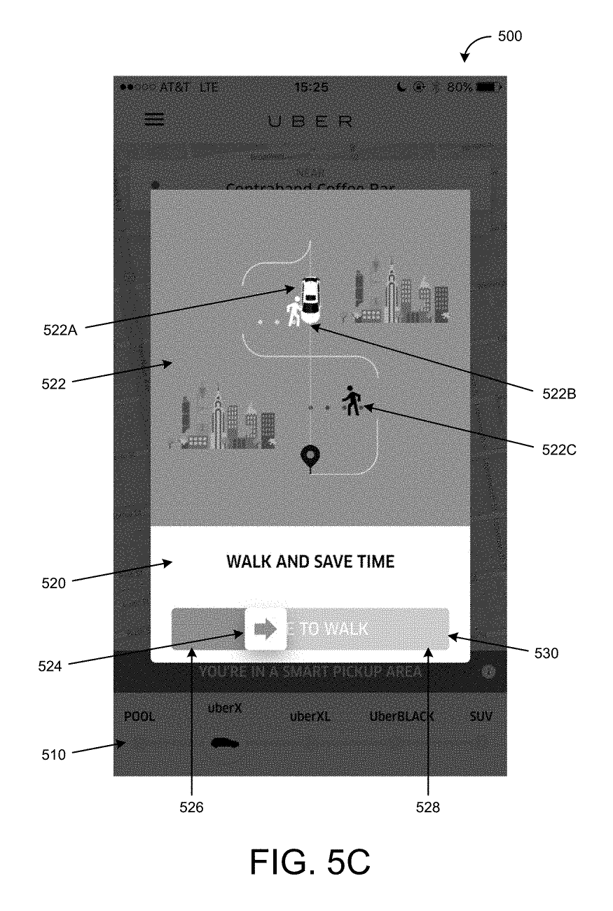

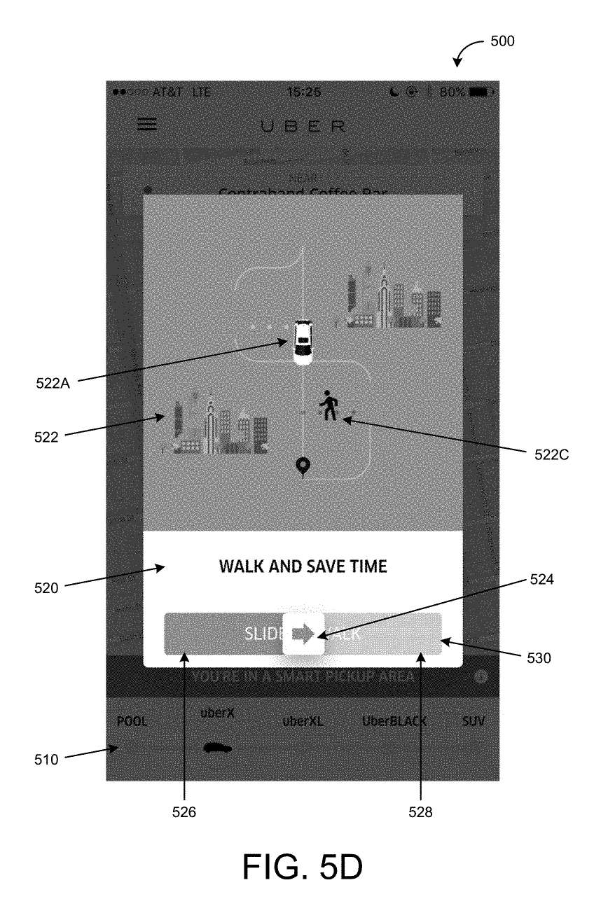

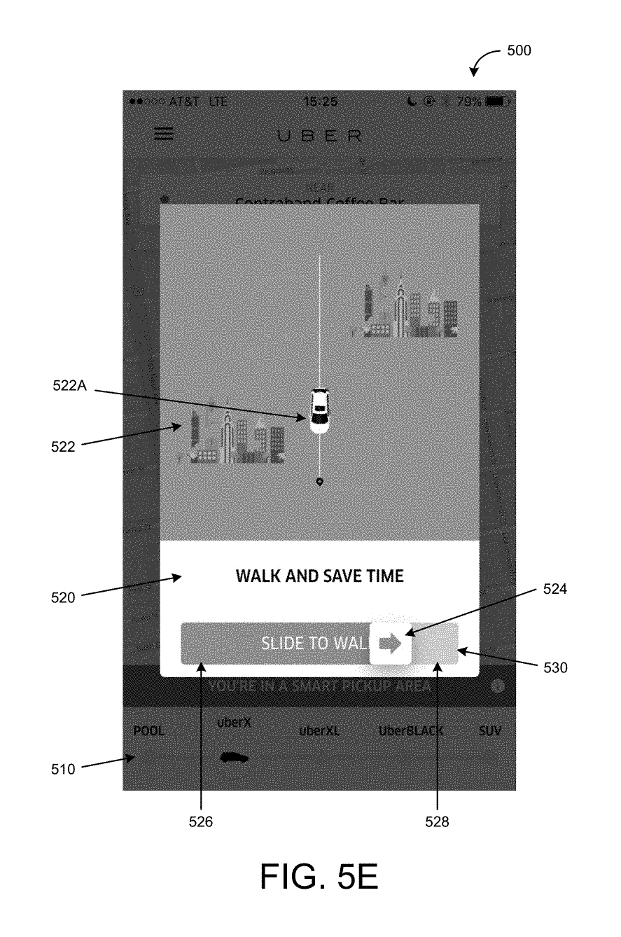

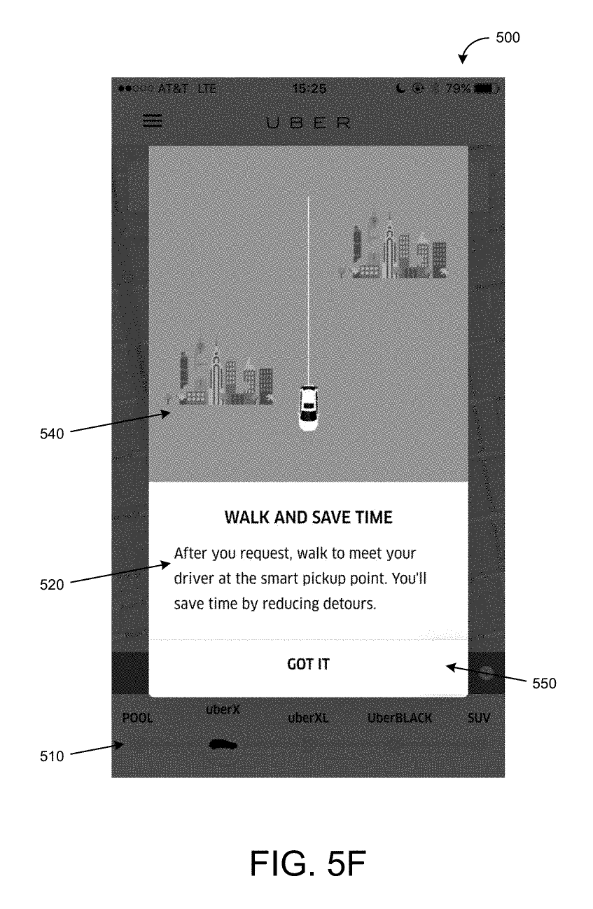

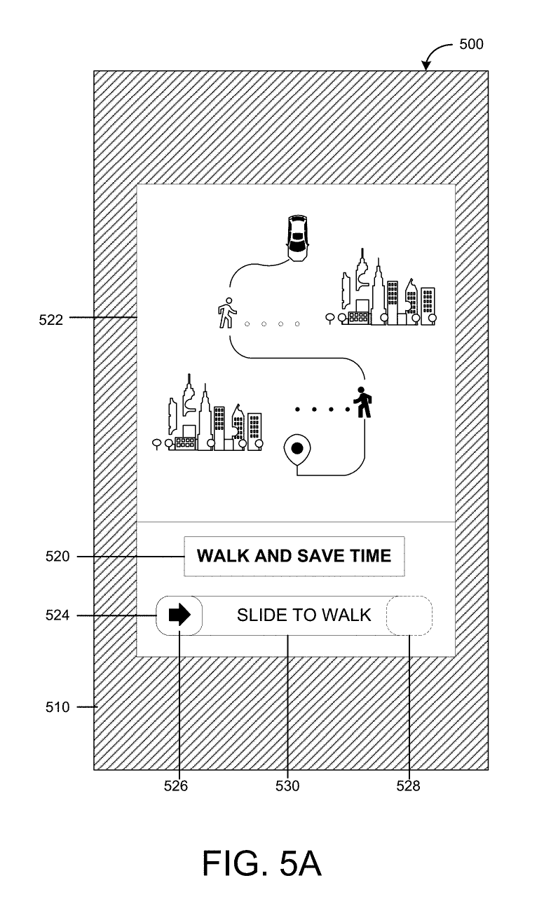

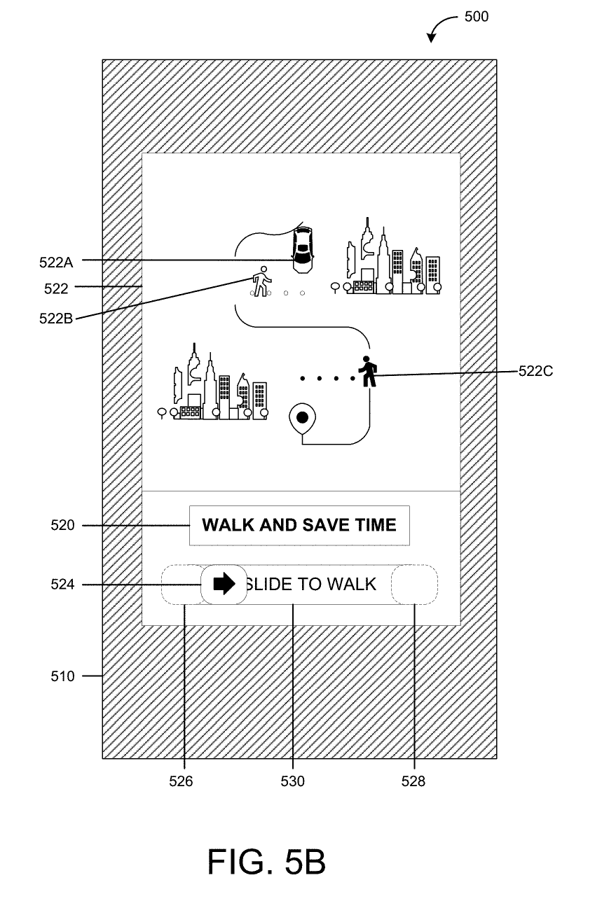

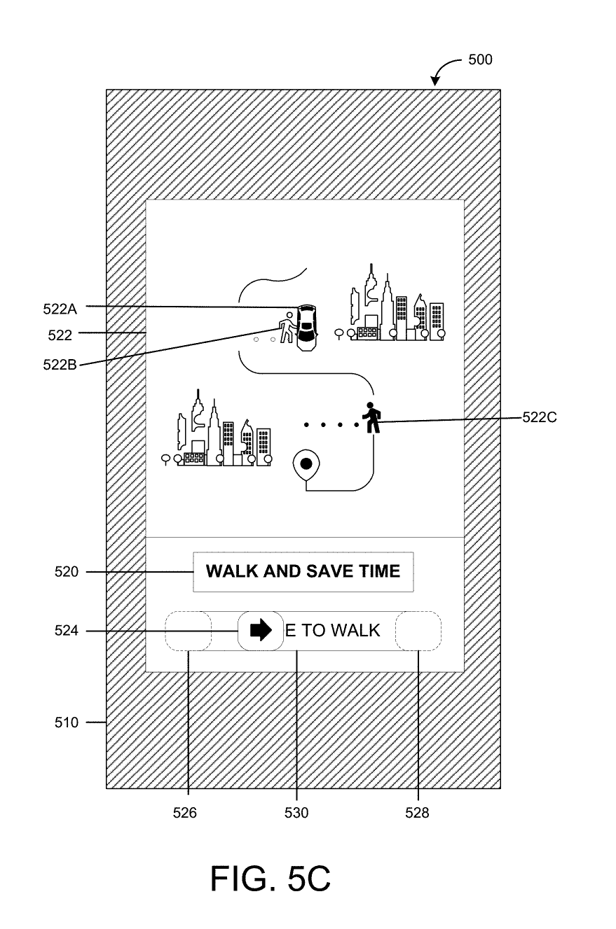

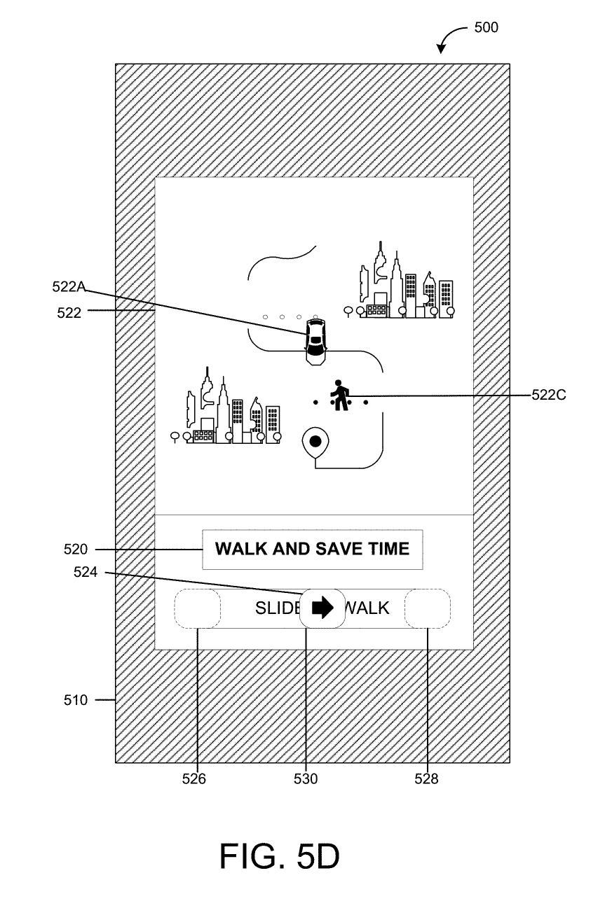

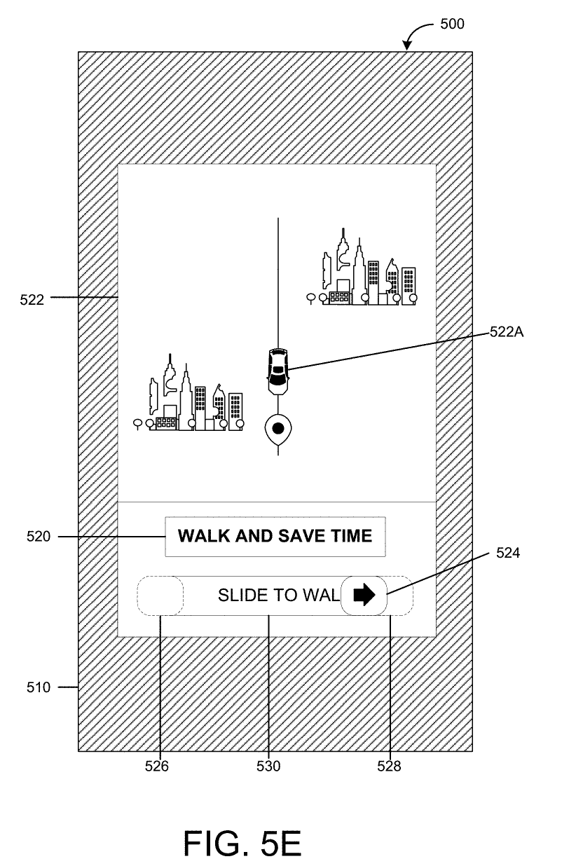

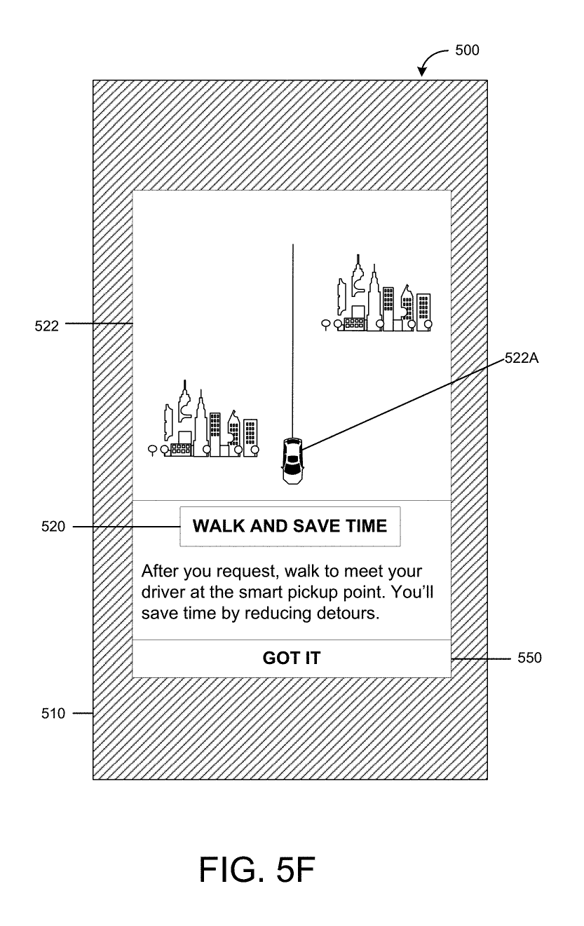

FIGS. 5A through 5F illustrate detailed example UIs to depict an operation of an in-application notification. The UI examples of FIGS. 5A through 5F are used to describe the interactive operation of the client application for illustrative purposes. Other graphics or content may be included or removed from individual examples of FIGS. 5A through 5F depending on various implementations.

For purpose of simplicity, the examples of FIGS. 5A through 5F are described with respect to a user (e.g., a requester) that is operating a service application to view information from a service arrangement system and/or to make a request for a service, such as a transport service. In the examples of FIGS. 5A through 5F, the service application has been instructed to display an interactive in-application notification as part of the UI of the service application. In some examples, the user has provided input about a service option or vehicle type (e.g., a carpooling vehicle type) and/or has not yet interacted with an interactive in-application notification about a new feature of this service option. Such a new feature, in this example, can correspond to providing requesters of the carpooling vehicle type walking directions to particular pickup locations for faster carpooling service.

FIG. 5A illustrates a UI 500 that is displayed by the service application on a display screen of a user's computing device. The UI 500 can include previously displayed content 510 before the in-application notification 520 is displayed as part of the UI 500. The in-application notification 520 can include a section for graphic content 522 and textual content about the service or new feature of the service (e.g., “Walk and save time”). The in-application notification 520 can also include an interactive sliding feature 524 that is provided on a track 530. The interactive sliding feature 524 can be positioned at a first, default position 526 and can be moved via user gesture input to a second, end position 528. The track 530, in some examples, can include textual content to explain to the user what to do in order to interact with the in-application notification 520. FIG. 5A can represent the in-application notification 520 at time t=0.

When the user selects the interactive sliding feature 524 and begins to drag the interactive sliding feature 524 from the first position to the second position, the graphic content 522 can begin to dynamically adjust accordingly. According to examples, the graphic content 522 can dynamically adjust at a same speed or rate or at a different speed or rate as the movement of the interactive sliding feature 524. In FIG. 5B, which represents time t=1, the user has moved the interactive sliding feature 524 toward the second position 528. The graphic content 522 has dynamically changed so that first graphic element 522A has moved down, the second graphic element 522B has moved to the right, and the third graphic element 522C has moved to the left. Similarly, in FIG. 5C, which represents time t=2, as the user has moved the interactive sliding feature 524 even more toward the second position 528, the graphic content 522 has dynamically changed accordingly.

Referring to FIG. 5D, which represents time t=3, the user has further moved the interactive sliding feature 524 toward the second position 528. In response, the graphic content 522 has been adjusted to illustrate the second graphic element 522B having entered the vehicle, represented by the first graphic element 522A, so that the second graphic element 522B is no longer present. Still further, as shown in FIG. 5E, which represents time t=4, the user has almost moved the interactive sliding feature 524 to the second position 528. At this time, the graphic content 522 is similarly at a state where the dynamic change or animation is almost complete.

FIG. 5F illustrates the UI 500 at time t=5, a time just after the user has moved the interactive sliding feature 524 to the second position 528. In this example, in response to the user moving the interactive sliding feature 524 to the second position 528, the service application has changed the notification 520 from being an interactive in-application notification to a static notification, such that the graphic content is now static graphic content 540. In addition, the service application has changed other characteristics of the notification 520 by removing the interactive sliding feature 524 and the track 530, as well as changing the size of the notification 520. The notification 520 can also include textual content that was previously unavailable that provides further instructions or information for the user and a selectable feature 550 to dismiss or remove the notification 520. In an alternate example, the service application can remove the notification 520 entirely in response to the user moving the interactive sliding feature 524 to the second position 528 or at a specified duration of time after such user input.

As illustrated in FIGS. 5A through 5F, the dynamic graphic content 522 can depict a dynamic illustration or animation showing that a first person can walk (e.g., illustrated by the dots) in a direction towards the vehicle and get into the vehicle, and that a second person can also walk in a direction towards the vehicle and get into the vehicle. Thus, such a notification can be an effective tool for educating the user about the feature or service option. In addition, the user may be required to interact with the notification in order to be able to dismiss or remove the notification from the UI.

Hardware Diagram

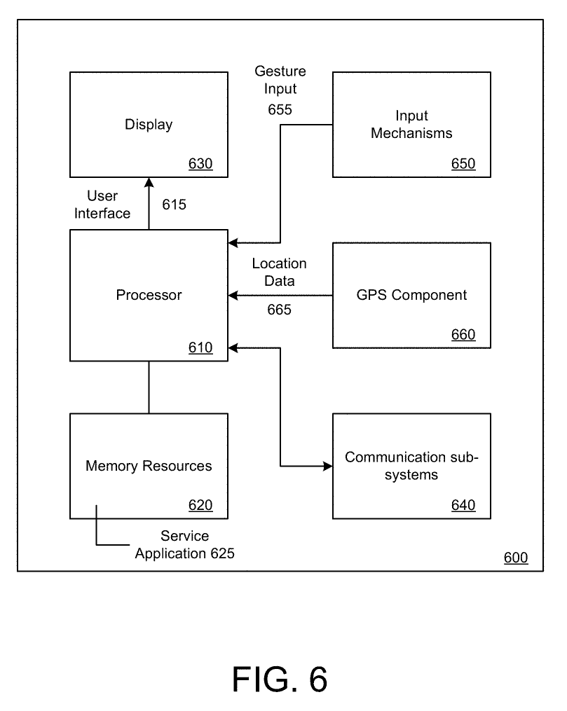

FIG. 6 is a block diagram that illustrates a computing device upon which examples described herein may be implemented. In some examples, a computing device 600 may correspond to a mobile computing device, such as a cellular device that is capable of telephony, messaging, and data services. The computing device 600 can correspond to a device operated by a requester or, in some examples, a device operated by the service provider that provides location-based services. Examples of such devices include smartphones, handsets, tablet devices, or in-vehicle computing devices that communicate with cellular carriers. The computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), and one or more location detection mechanisms (e.g., GPS component) 660. In some examples, at least one of the communication sub-systems 640 sends and receives cellular data over data channels and voice channels. The communications sub-systems 640 can include a cellular transceiver and one or more short-range wireless transceivers. The processor 610 can exchange data with a service arrangement system (not illustrated in FIG. 6) via the communications sub-systems 640.

The processor 610 can provide a variety of content to the display 630 by executing instructions stored in the memory resources 620. The memory resources 620 can store instructions for the service application 625. For example, the processor 610 is configured with software and/or other logic to perform one or more processes, steps, and other functions described with implementations, such as described by FIGS. 1 through 5F, and elsewhere in the application. In particular, the processor 610 can execute instructions and data stored in the memory resources 620 in order to provide information or content about location-based services based on the user's current location, as described in FIGS. 1 through 5F. The processor 610 can also execute instructions for presenting a variety of UIs 615, such as described in FIGS. 1 through 5F, including presenting an in-application notification as part of a UI 615.

In some examples, the computing device 600 can determine a location data point 665 of the current location of the computing device 600 from the GPS component 660. Based on the location data point 665, information about one or more services available at the location can be displayed on a UI 615. For example, the communications sub-systems 640 can provide the location data point 665 to a remote system and can receive data about the available service(s) for the user. In other examples, the service application 625 can display an in-application notification associated with a service option available to the user at the user's location. The user can interact with the in-application notification using gesture input 655 via one or more input mechanisms 650, such as a touch-sensitive display (e.g., in combination with the display 630), such as described in FIGS. 1 through 5F. While FIG. 6 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A non-transitory computer-readable medium storing instructions that, when executed by one or more processors of a computing device, cause the computing device to:
receive, from a touch-sensitive display, a first input on a user interface, the first input specifying a parameter for a first service option;
provide, on the touch-sensitive display, an in-application notification associated with the first service option provided with the user interface, the in-application notification including graphic content associated with the first service option and an interactive feature that is responsive to a second input; and
responsive to the second input, dynamically adjust the graphic content of the in-application notification.

2. The non-transitory computer-readable medium of claim 1, wherein the interactive feature is a sliding interactive feature that is responsive to the second input.

3. The non-transitory computer readable medium of claim 2, wherein the second input is a gesture input, and wherein the instructions further cause the computing device to:
receive, via the touch-sensitive display, the gesture input; and
based on the gesture input, move the interactive sliding feature from a first position to a second position.

4. The non-transitory computer-readable medium of claim 3, wherein the instructions further cause the computing device to:
present textual content in the in-application notification in response to the interactive sliding feature being moved to the second position.

5. The non-transitory computer-readable medium of claim 3, wherein the interactive sliding feature corresponds to a graphic feature that is provided on a path, the path having one or more turns, wherein the graphic feature can be moved along the path between the first position and the second position, and wherein the graphic feature and the path are part of the graphic content of the in-application notification.

6. The non-transitory computer-readable medium of claim 3, wherein the interactive sliding feature is provided on a track defined by a pair of lateral edges, and wherein the interactive sliding feature can be moved along the track between the first position to the second position.

7. The non-transitory computer-readable medium of claim 6, wherein the instructions further cause the computing device to:
remove the interactive sliding feature and the track from the in-application notification in response to the interactive sliding feature being moved to the second position.

8. The non-transitory computer-readable medium of claim 1, wherein the instructions further cause the computing device to:
determine whether a user has previously interacted with the in-application notification; and
based on the determination that the user had not previously viewed the in-application notification display the in-application notification in response to determining that the user had not previously viewed the in-application notification.

9. The non-transitory computer-readable medium of claim 1, wherein the instructions further cause the computing device to:
determine whether a user has previously specified at least a parameter for the first service option; and
based on the determination that the user had not previously specified at least the parameter for the first service option, display the in-application notification.

10. The non-transitory computer-readable medium of claim 1, wherein the instructions further cause the computing device to:
receive, via the touch-sensitive display, a request for the first service option; and
transmit, to a network service over one or more networks, a request message including an identifier of the first service option and location information corresponding to the parameter.

11. The non-transitory computer-readable medium of claim 10, the instructions cause the computing device to:
present the in-application notification in response to receiving a message from the network service.

12. The non-transitory computer-readable medium of claim 1, wherein the parameter corresponds to a pickup location for a transport service or a meeting location for a delivery service.

13. A method of providing information on a computing device, the method being performed by one or more processors of the computing device and comprising:
presenting a user interface of a client application;
receiving a first input on the user interface;
providing an in-application notification provided with the user interface that includes graphic content and an interactive sliding feature that is responsive to a gesture input, the in-application notification being in a first state;
receiving the gesture input;
based on the gesture input, moving the interactive sliding feature of the in-application notification from a first position to a second position;
as the interactive sliding feature moves, dynamically adjusting the graphic content on the in-application notification; and
in response to the interactive sliding feature being moved to the second position, changing a state of the in-application notification from the first state to a second state.

14. The method of claim 13, wherein the interactive sliding feature is provided on a track defined by a pair of lateral edges, and wherein the interactive sliding feature can be moved along the track between the first position to the second position.

15. The method of claim 14, wherein changing the state of the in-application notification from the first state to the second state includes:
removing the interactive sliding feature and the track from the in-application notification; and
presenting textual content in the in-application notification in place of the interactive sliding feature.

16. The method of claim 13, wherein the interactive sliding feature corresponds to a graphic feature that is provided on a path, the path having one or more turns, wherein the graphic feature can be moved along the path between the first position and the second position, and wherein the graphic feature and the path are part of the graphic content of the in-application notification.

17. A non-transitory computer-readable medium storing instructions that, when executed by one or more processors of a computing device, cause the computing device to:
present, on a touch-sensitive display of the computing device, a user interface of a client application, the user interface including a set of selectable features each corresponding to a service option;
receive, from the touch-sensitive display, a first input on the user interface, the first input specifying a parameter for a first service option; and
determine whether a first in-application notification has been previously displayed by the client application.

18. A non-transitory computer-readable medium of claim 17, wherein upon a determination that the first in-application notification has not been previously displayed, the instructions further cause the computing device to:
present, on the touch-sensitive display, the first in-application notification that includes a first graphic content and an interactive sliding feature that is responsive to a gesture input;
receive, via the touch-sensitive display, the gesture input; and
based on the gesture input, move the interactive sliding feature from a first position to a second position.

19. A non-transitory computer-readable medium of claim 18, wherein the instructions further cause the computing device to:
remove the first in-application notification once the gesture input is received.

20. A non-transitory computer readable medium of claim 17, wherein upon a determination that the first in-application notification has been previously displayed by the client application, the instructions further cause the computing device to:
present, on the touch-sensitive display, a second in-application notification that includes a static second graphic content.
